(19) United States
(12) Patent Application Publication
(10) Pub. No.: US 2014/0377129 A1
(43) Pub. Date: Dec. 25, 2014

(54) Palladium Alloy for Electric and Electronic Appliances

(71) Applicant: Tokuriki Honten Co., LTD., Tokyo (JP)

(72) Inventors: Ryu Shishino, Tokyo (JP); Keiju Uruu, Tokyo (JP)

(21) Appl. No.: 14/369,544

(22) PCT Filed: Dec. 17, 2012
(86) PCT No.: PCT/JP2012/082712

§ 371 Date: Jun. 27, 2014

(30) Foreign Application Priority Data
Dec. 27, 2011 (JP) 2011-286293

(51) Int. Cl. H01B 1/02; C22C 5/04; C22C 30/02

(52) U.S. Cl. CPC H01B 1/02; C22C 30/02; C22C 5/04
USPC 420/587

(57) ABSTRACT

In materials using an Ag—Pd—Cu alloy for electric and electronic appliances, an improvement in weakness (fragility) to bending attained by adding Pt has been proposed since a material excellent in bending workability has been in demand. On the other hand, the proposal has entailed a problem of a considerable reduction in hardness though it depends on the added Pt amount. Also, there has been a problem that a material cost is increased by the addition of Pt.

By adding 0.1 to 5.0 mass % of Co or 0.1 to 5.0 mass % of Ni to 20 to 50 mass % of Ag, 20 to 50 mass % of Pd, and 10 to 40 mass % of Cu, the hardness when precipitation hardened after plastic working was improved to 280 to 480 HV, and the bending workability was attained.

### TECHNICAL FIELD

The present invention relates to a Pd alloy usable as a material for electric and electronic appliances.

### BACKGROUND ART

Materials to be used for electric and electronic appliances are required to have various properties such as low contact resistance and excellent corrosion resistance. Therefore, expensive noble metal alloys such as a Pt alloy, an Au alloy, a Pd alloy, and an Ag alloy have widely been used.

However, hardness (abrasion resistance) and so forth are required in addition to the low contact resistance and the corrosion resistance according to the intended use (testing probe or the like for semiconductor integrated circuit or the like). Accordingly, a Pt alloy and an Ir alloy which exhibits high hardness after plastic working, an Au alloy and a Pd alloy capable of precipitation hardening, and the like are desirably used (for example, Patent Literature 1 and Patent Literature 2).

Particularly, as to the testing probe for semiconductor integrated circuits and the like (hereinafter referred to as “probe”), various types (forms) of probes such as cantilever type, cobra type, and spring type are used due to various test objects, and required properties are varied depending on the probe types.

In the case where the hardness is regarded important, it is recommendable to use the Pt alloy and Ir alloy which exhibits high hardness after plastic working or the Au alloy and Pd alloy which exhibit high hardness when precipitation hardened.

However, in many cases, the materials having high hardness which is attained by the precipitation hardening also have difficulty in being subjected to wire drawing and weakness (fragility) to bending. Therefore, in the case of a probe which is obtained by performing bending processing on a tip thereof, even if wire drawing can be performed, the bending portion of the probe is sometimes broken during the bending processing of a probe pin or due to fatigue of the bending portion caused by several tens of thousands of repetitive testing operations performed after incorporating the probe pin into a probe card during the property test of semiconductor integrated circuits or the like.

Therefore, in the case of the probe having the tip on which the bending processing is performed, there is a demand for a material having excellent bending workability which enables to suppress generation of a wrinkle or a crack during the bending in addition to the low contact resistance, corrosion resistance, and hardness.

In response to the demand related to the mechanical properties, improvement in weakness (fragility) to bending attained by adding 1.0 to 20 mass % of Pt to a Pd alloy has been proposed (for example, Patent Literature 3).

### CITATION LIST

### Patent Literature

Patent Literature 1: JP Pat. No. 4176133
Patent Literature 2: JP Pat. No. 4216823

### Patent Literature 3: PCT/JP2011/067375

### SUMMARY OF INVENTION

### Technical Problem

However, according to the art, there has been a problem of a considerable reduction in hardness though it depends on the added Pt amount. Also, there has been a problem that a material cost is increased by the addition of Pt.

### Solution to Problem

Therefore, the present invention is configured by adding 0.1 to 5.0 mass % of Co and/or 0.1 to 5.0 mass % of NiO to an Ag—Pd—Cu alloy comprising 20 to 50 mass % of Ag, 20 to 50 mass % of Pd, and 10 to 40 mass % of Cu.

The reason for setting the amount of Co to be added to 0.1 to 5.0 mass % is to improve bending workability. The effect of improving bending workability is not attained when the added Co amount is less than 0.1 mass %, while workability is deteriorated when the added Co amount exceeds 5 mass %.

The reason for setting the amount of Ni to be added to 0.1 to 5 mass % is to improve bending workability, too. The effect of improving bending workability is not attained when the added Ni amount is less than 0.1 mass %, while predetermined hardness is not attained when the added Ni amount exceeds 5 mass %.

To the alloy of the present invention obtained by adding Co and/or Ni to the Ag—Pd—Cu alloy, 0.1 to 10 mass % of Au and 0.1 to 3.0 mass % of at least one of Pt, Re, Rh, Ru, Si Sn, Zn, B, In, Nb, and Ta are further added as additive elements which improve properties depending on a usage.

The reason for adding 0.1 to 10 mass % of Au is to improve oxidization resistance and hardness. The effect is not attained when the added Au amount is less than 0.1 mass %, while the workability is deteriorated when the added Au amount exceeds 10 mass %.

The reason for adding 0.1 to 3.0 mass % of at least one of Pt, Re, Rh, Ru, Si Sn, Zn, B, In, Nb, and Ta is to improve hardness. Re, Rh, and Ru act also as elements having effect of refining crystal grains.

### Advantageous Effects of Invention

According to the present invention described above, there is provided a material which is improved in mechanical properties as an alloy, i.e., which has hardness of 280 to 480 HV when precipitation hardened after plastic working, low contact resistance, excellent corrosion resistance, high hardness, and bending workability and attains a low material cost.

### BRIEF DESCRIPTION OF DRAWINGS

FIG. 1 is a diagram illustrating a bending working test.

### DESCRIPTION OF EMBODIMENTS

One embodiment of the present invention will be described.

Co and/or Ni and additive elements for improving properties depending on usages were added to an Ag—Pd—Cu alloy by vacuum melting to prepare ingots (φ10×L100).

After eliminating melting defects such as shrinkage cavity, wire drawing and a solution treatment (800° C.×1 hr; in a mixed atmosphere of H₂ and N₂) were repeated to attain φ2.0, and wire drawing was performed to attain a final section reduction rate of about 75%, thereby obtaining test samples (φ1.0×L). Precipitation hardening was performed under the conditions of at 300° C. to 500° C.×1 hr in a mixed atmosphere of H₂ and N₂.

Hardness of each of the test samples was measured by using a surface Vickers hardness tester at HV 0.2.

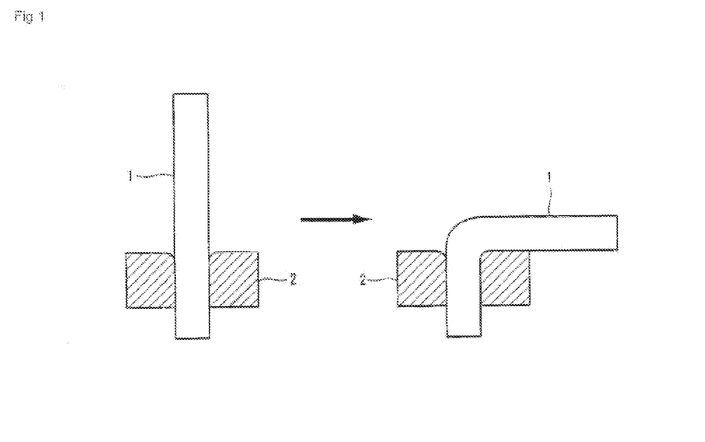

The bending workability test was conducted by fixing the test sample 1 with a jig 2 with R 0.5 and repetitively bending the test sample 1 until it was broken. The number of bendings before the breakage occurs was examined. Bending of 90 degrees or more was counted as one bending, and 0 indicates that the bending was short of 90 degrees (see FIG. 1).

The compositions, the numbers of bendings until breakage, and the hardness after the working and precipitation hardening are shown in Table 1.

TABLE 1

| | | Bending | Hardness (HV0.2) | |
|---|---|---|---|---|
| | | numbers to | Rolling processed | Precipitation |
| | Composition (mass %) | break | material | hardened materials |
| Example 1 | 29.00Ag—40.00Pd—29.00Cu—1.00Ni—1.00In | 2 | 280 | 480 |
| Example 2 | 38.00Ag—39.00Pd—19.00Cu—3.00Co—1.00Pt | 4 | 300 | 390 |
| Example 3 | 50.00Ag—20.00Pd—18.80Cu—1.00Co—10.00Au—0.10Re | 3 | 260 | 280 |
| Example 4 | 20.00Ag—50.00Pd—24.70Cu—5.00Ni—0.10Au—0.10Rh—0.10Ta | 5 | 290 | 360 |
| Example 5 | 42.30Ag—42.40Pd—10.00Cu—5.00Co—0.10Ni—0.10Ru—0.10Zn | 6 | 290 | 340 |
| Example 6 | 29.20Ag—29.40Pd—40.00Cu—0.10Co—1.00Ni—0.10Si—0.10Sn—0.10B | 3 | 280 | 310 |
| Example 7 | 29.00Ag—40.00Pd—30.00Cu—1.00Co | 4 | 290 | 440 |
| Example 8 | 28.90Ag—40.00Pd—30.00Cu—1.00Co—0.10Au | 4 | 290 | 450 |
| Example 9 | 28.90Ag—40.00Pd—30.00Cu—1.00Co—0.10Pt | 4 | 290 | 450 |
| Example 10 | 28.90Ag—40.00Pd—30.00Cu—1.00Co—0.10Re | 4 | 290 | 450 |
| Example 11 | 28.90Ag—40.00Pd—30.00Cu—1.00Co—0.10Rh | 4 | 290 | 450 |
| Example 12 | 28.90Ag—40.00Pd—30.00Cu—1.00Co—0.10Ru | 4 | 290 | 450 |
| Example 13 | 28.90Ag—40.00Pd—30.00Cu—1.00Co—0.10Si | 4 | 290 | 450 |
| Example 14 | 28.90Ag—40.00Pd—30.00Cu—1.00Co—0.10Sn | 4 | 290 | 450 |
| Example 15 | 28.90Ag—40.00Pd—30.00Cu—1.00Co—0.10Zn | 4 | 290 | 450 |
| Example 16 | 28.90Ag—40.00Pd—30.00Cu—1.00Co—0.10B | 4 | 290 | 450 |
| Example 17 | 28.90Ag—40.00Pd—30.00Cu—1.00Co—0.10In | 4 | 290 | 450 |
| Example 18 | 28.90Ag—40.00Pd—30.00Cu—1.00Co—0.10Nb | 4 | 290 | 450 |
| Example 19 | 28.90Ag—40.00Pd—30.00Cu—1.00Co—0.10Ta | 4 | 290 | 450 |
| Example 20 | 29.00Ag—40.00Pd—30.00Cu—1.00Ni | 5 | 290 | 440 |
| Example 21 | 28.90Ag—40.00Pd—30.00Cu—1.00Ni—0.10Au | 5 | 290 | 440 |
| Example 22 | 28.90Ag—40.00Pd—30.00Cu—1.00Ni—0.10Pt | 5 | 290 | 440 |
| Example 23 | 28.90Ag—40.00Pd—30.00Cu—1.00Ni—0.10Re | 5 | 290 | 440 |
| Example 24 | 28.90Ag—40.00Pd—30.00Cu—1.00Ni—0.10Rh | 5 | 290 | 440 |
| Example 25 | 28.90Ag—40.00Pd—30.00Cu—1.00Ni—0.10Ru | 5 | 290 | 440 |
| Example 26 | 28.90Ag—40.00Pd—30.00Cu—1.00Ni—0.10Si | 5 | 290 | 440 |
| Example 27 | 28.90Ag—40.00Pd—30.00Cu—1.00Ni—0.10Sn | 5 | 290 | 440 |
| Example 28 | 28.90Ag—40.00Pd—30.00Cu—1.00Ni—0.10Zn | 5 | 290 | 440 |
| Example 29 | 28.90Ag—40.00Pd—30.00Cu—1.00Ni—0.10B | 5 | 290 | 440 |
| Example 30 | 28.90Ag—40.00Pd—30.00Cu—1.00Ni—0.10In | 5 | 290 | 440 |
| Example 31 | 28.90Ag—40.00Pd—30.00Cu—1.00Ni—0.10Nb | 5 | 290 | 440 |
| Example 32 | 28.90Ag—40.00Pd—30.00Cu—1.00Ni—0.10Ta | 5 | 290 | 440 |
| Example 33 | 28.00Ag—40.00Pd—30.00Cu—1.00Co—1.00Ni | 6 | 300 | 430 |
| Example 34 | 27.90Ag—40.00Pd—30.00Cu—1.00Co—1.00Ni—0.10Au | 6 | 300 | 430 |
| Example 35 | 27.90Ag—40.00Pd—30.00Cu—1.00Co—1.00Ni—0.10Pt | 6 | 300 | 430 |
| Example 36 | 27.90Ag—40.00Pd—30.00Cu—1.00Co—1.00Ni—0.10Re | 6 | 300 | 430 |
| Example 37 | 27.90Ag—40.00Pd—30.00Cu—1.00Co—1.00Ni—0.10Rh | 6 | 300 | 430 |
| Example 38 | 27.90Ag—40.00Pd—30.00Cu—1.00Co—1.00Ni—0.10Ru | 6 | 300 | 430 |
| Example 39 | 27.90Ag—40.00Pd—30.00Cu—1.00Co—1.00Ni—0.10Si | 6 | 300 | 430 |
| Example 40 | 27.90Ag—40.00Pd—30.00Cu—1.00Co—1.00Ni—0.10Sn | 6 | 300 | 430 |
| Example 41 | 27.90Ag—40.00Pd—30.00Cu—1.00Co—1.00Ni—0.10Zn | 6 | 300 | 430 |
| Example 42 | 27.90Ag—40.00Pd—30.00Cu—1.00Co—1.00Ni—0.10B | 6 | 300 | 430 |
| Example 43 | 27.90Ag—40.00Pd—30.00Cu—1.00Co—1.00Ni—0.10In | 6 | 300 | 430 |
| Example 44 | 27.90Ag—40.00Pd—30.00Cu—1.00Co—1.00Ni—0.10Nb | 6 | 300 | 430 |
| Example 45 | 27.90Ag—40.00Pd—30.00Cu—1.00Co—1.00Ni—0.10Ta | 6 | 300 | 430 |
| Comparative | 29.00Ag—40.00Pd—30.00Cu—1.00In | 0 | 280 | 490 |
| Example 1 | | | | |
| Comparative | 40.00Ag—40.00Pd—20.00Cu | 0 | 300 | 420 |
| Example 2 | | | | |
| Comparative | 50.00Ag—20.00Pd—20.00Cu—10.00Au | 1 | 260 | 290 |
| Example 3 | | | | |
| Comparative | 20.00Ag—50.00Pd—29.90Cu—0.10Au | 0 | 290 | 400 |
| Example 4 | | | | |
| Comparative | 45.00Ag—45.00Pd—10.00Cu | 0 | 290 | 370 |
| Example 5 | | | | |
| Comparative | 30.00Ag—30.00Pd—40.00Cu | 1 | 280 | 320 |
| Example 6 | | | | |

From the results shown in Table 1, it was revealed that the number of bendings of the precipitation hardened materials of Comparative Examples 1 to 6 in each of which Co or Ni was not added to the Ag—Pd—Cu alloy is small, which was 1 or less, and Comparative Examples 1 to 6 were broken during or after the bending.

Examples in which Ni was added were capable of two or more bendings to show the improvement in bending workability.

Likewise, another examples of the present invention, the precipitation hardened materials of the alloys obtained by adding Co and/or Ni and at least one of Au, Pt, Re, Rh, Ru, Si Sn, Zn, B, In, Nb, and Ta to the Ag—Pd—Cu alloy were capable of two or more bendings to show the improvement in bending workability.

### REFERENCE SIGNS LIST

1: Test sample
2: Jig

1. A Pd alloy for electric and electronic appliances, characterized by: adding 0.1 to 5.0 mass % of Co or 0.1 to 5.0 mass % of NiO to 20 to 50 mass % of Ag, 20 to 50 mass % of Pd, and 10 to 40 mass % of Cu; having hardness of 280 to 480 HV when precipitation hardened after plastic working; and having bending workability.

2. A Pd alloy for electric and electronic appliances, characterized by: adding 0.1 to 5.0 mass % of Co and 0.1 to 5.0 mass % of NiO to 20 to 50 mass % of Ag, 20 to 50 mass % of Pd, and 10 to 40 mass % of Cu; having hardness of 280 to 480 HV when precipitation hardened after plastic working; and having bending workability.

3. The Pd alloy for electric and electronic appliances according to claim 1 or claim 2, characterized by further adding 0.1 to 10 mass % of Au and 0.1 to 3.0 mass % of at least one of Pt, Re, Rh, Ru, Si Sn, Zn, B, In, Nb, and Ta.
